(19) United States
(12) Patent Application Publication
(10) Pub. No.: US 2006/0060527 A1
(43) Pub. Date: Mar. 23, 2006

(54) Petrol-biochemical method for the treatment and prevention of oil-in-water and water-in-oil emulsions in oil-wells and surface equipment

(76) Inventors: Janos Balazs, Bihari u (HU); Imre Mecs, Szivarvany u (HU); Sandor Puskas, Varadi u (HU); Miklos Hlatki, Gyorgy u (HU); Miklos Kalman, Kossuth u (HU); Gyula Lengyel, Szilleri sgt (HU); Zsolt Molnar, Gyergyo u (HU)

Correspondence Address: WELSH & KATZ, LTD, 120 S RIVERSIDE PLAZA, 22ND FLOOR, CHICAGO, IL, 60606, US

(21) Appl. No.: 10/530,773

(22) PCT Filed: Oct. 7, 2003
(86) PCT No.: PCT/HU03/00078

§ 371 Date: Oct. 26, 2005

(30) Foreign Application Priority Data
Oct. 7, 2002 (HU) P0203394
Sep. 18, 2003 (HU) P0303067

(51) Int. Cl. C02F 3/00

(52) U.S. Cl. 210/610

(57) ABSTRACT

The method for preventing the formation of oil-win-water and/or water-in-oil emulsions and/or for breaking up emulsions already formed, comprises the steps of: (a) adding tensides, materials for increasing viscosity, industrial surfactants, and microorganisms capable of breaking down crude oil components or derivatives and producing at least one type of tenside, to the emulsion already formed or into the device containing the crude oil in which the formation of the emulsion to be prevented, optionally together with additives required for the reproduction of said microorganisms; (b) providing an appropriate temperature for the microorganisms after the addition of the materials listed above; (c) allowing the microorganisms to reproduce and act for a predetermined period of time; (d) checking the results of the treatment; and (e) optionally repeating steps (a) to (d) at least once more, preferably at least three more times.

The present invention relates to a method for preventing the formation of oil-in-water and/or water-in-oil emulsions and/or for breaking up emulsions already formed, comprising (a) adding tensides, materials for increasing viscosity, industrial surfactants, and microorganisms capable of breaking down crude oil components or derivatives and producing at least one type of tenside, to the emulsion already formed or into the device containing the crude oil in which the formation of the emulsion to be prevented, optionally together with additives required for the reproduction of said microorganisms; (b) providing an appropriate temperature for the microorganisms after the addition of the materials listed above; (c) allowing the microorganisms to reproduce and act for a predetermined period of time; (d) checking the results of the treatment; and (e) optionally repeating steps (a) to (d) at least once more, preferably at least three more times.

Eighty percent of the crude oil produced in the world is brought up to the surface in the form of emulsion, therefore, demulsification is one of the most expensive process of the crude oil production and processing. Kinetic stability of the emulsions is maintained by the natural surfactants of the crude oil, such as asphaltenes, vaxes and so-called organic hydrophobic paraffin derivatives [Li, Mingyuan, A. A. Christy, J. Sjöblom, Emulsions—A Fundamental and Practical Approach., pp. 157-172, eds.: J. Sjöblom, Kluwer Acad. Publishers, Netherland (1992); J. Sjöblom, Encyclopedic Handbook of Emulsion Technology, pp. 412-414, Marcel Dekker, Inc. New York (2001)]. Graham published definite results on this field after storing paraffin-based structured crude oil on different temperatures, and separating the solid components by centrifugation [Graham, D. E., Crude oil emulsions. Their Stability and Resolutions, in: Chemicals in the Oil Industry, eds.: Ogden, P. H., Royal Soc. Chem. (1988)]. This resulted in significant decrease with respect to the rheological properties and emulsifying ability. Upon gradually adding back the centrifuged sediment containing asphaltene, vax and paraffin to the crude oil, gradual increase of the rheological and emulsification properties was observed. Puskás et al. isolated organic hydrophobic paraffin derivatives (carbonyls) from asphaltene-paraffin-vax precipitated in oil-producing wells, which proved to be a very effective emulsifier [S. Puskás, J. Balázs, A. Farkas, I. Regdon, O. Berkesi, I. Dékány, The significance of colloid hydrocarbon in crude oil production, Part I. New aspects of the Stability and Theological properties of water-crude oil emulsions., Colloid and Surfaces A: Physicochemical and Engineering Aspects 113, pp. 279-293 (1996)].

Natural emulsifiers, accumulated on the water-oil interface, decrease the tension and increase the viscosity on the interface, thus inhibit the confluence of the droplets. Earlier studies showed that the low tension is necessary, but not sufficient for stability. Based on the results of studies of interfacial rheology, there is a direct connection between the elasticity and viscosity of the interfacial film and the stability of emulsions [Lakatosné Szabó J., Lakatos L, Interfacial Rheological properties of crude oil—water systems, Journal of Hungarian Chemistry 21, pp. 385-393 (1985)].

Considering that crude oil and oilfield water form very stable water-in-oil or complex oil-water-oil and/or water-oil-water emulsions, which, in many cases, only separated by the available physical and chemical methods with difficulty, there is a great need for furthering the development of demulsification technology used in the industry. It is well known from the art and practice that the efficiency of every significant demulsification technique depends on a series of physico-chemical and technological parameters [Pordnjüsev, G. N., Stabilization and destabilization of crude oil emulsions” Publisher: Nedra (1982)].

A key step in demulsification is the break-up of the emulsifying film (interface) surrounding the water or oil droplets so as to achieve coalescence or gravitational sedimentation. Under industrial conditions, any or all of the following technique can be used to carry out this process:
Providing conditions characterized by low turbulence and flow-rate to enable the gravitational separation and removal of oil, water and solid material.
Increasing the temperature of the emulsion.
Using chemicals developed for demulsification.
Using electric fields to facilitate coalescence.
Changing the physical properties of the emulsion by the addition of diluent (for example gasoline) or water.

Since different crude oils can form very different emulsion with respect to structure and kinetics, all of the above-listed demulsification technique is unique, and only characterize quantitatively the given system.

Mechanical Methods

the choice of mechanical devices is mainly based on earlier experience. As the amount of water produced increases during the lifetime of the oilfield, the set of existing devices widens according to the needs.

Modern demulsification devices belong to two main classes: free water (brine) separators and demulsificators. A free water (brine) separator is typically a device for the separation of free water from the well-stream, before the actual start of demulsification.

In a demulsification device, demulsification is facilitated by introduction of heat, use of electrostatic grids or mechanical devices to facilitate coalescence, such as inserts or deflectors. A disadvantage of mechanical demulsification is the low efficiency, and it can only be used for the demulsification of easily separable emulsions.

Thermal Methods

Introduction of heat in demulsification technologies used in oilfields is usually enhances the efficacy of demulsification. It only occurs very rarely, however, that the introduction of heat alone is sufficient for demulsification. This is only possible for well-stream having paraffin as primary emulsifier. Temperatures above the melting point of paraffin (50 to 65° C.) can completely destabilize the emulsion.

It is preferred to minimize the amount of heat introduced because in that case the light distillates are not lost in the gas/steam phase, and the heating gas consumption can be minimized. A disadvantage of the thermal methods is that demulsification of highly stable emulsion is only possible at very high temperatures, such as around 80° C., which consumes significantly higher amount of energy, as well as there is a significant loss in light distillates.

Electric Methods

Electric fields have an effect on the surface tension of droplets so as to provoke the rearrangement of polar molecules. This method alone only rarely results complete demulsification, therefore it is frequently combined with the addition of chemicals, or the increase of the temperature. Electric methods are used only with emulsion having low water content, since free water can cause shorts in the demulsificator grid.

Chemical Methods

Demulsification compounds are usually necessary for the destabilization of crude oil emulsions. These chemicals facilitate the break-up of the interfacial layers stabilizing dispersed droplets. In order to facilitate phase separation, however, introduction of heat is also necessary in most cases. The success of chemical demulsification processes depends on several factors:
Continuous introduction of suitable chemical(s) into the emulsion in sufficient amounts.
Complete mixing-in of the chemical(s) in the emulsion.
Introduction of sufficient amount of heat into the emulsion to facilitate or complete demulsification.
Providing enough time for the separation of emulsion droplets within the treatment containers.

The cost of chemical demulsification is relatively low, and it can be carried out without stopping production. The chemicals used can be changed on-the-fly, depending on the changes in the properties of the emulsion and of the produced or processed crude oil.

In order to achieve more efficient production, the first step in selecting the demulsification chemicals is to know the characteristics of the crude oil or emulsions. Density, solid material and water contents must be determined. Crude oils must be classified into asphaltene- or paraffin-based raw oils, and asphaltene and paraffin content must also be determined. If the demulsification takes place below the melting point of paraffin, cloud point of crude oil has to also be determined. This information helps to select the temperature of treatment.

One must know the inorganic material content of the crude oil, and types of the solid materials. Next comes the study of the interfacial layer, and determination of its composition. Based on this information several crucial crude-oil emulsifier can be identified, and further interfacial components to be treated can be distinguished.

The economic benefit of demulsification procedures depends on the right choice of the chemical and its use. With respect of the type of emulsion and amounts used, widely versatile systems require chemicals which are effective in broad concentration ranges. But if the chemicals used do not have wide demulsification range, the over or under-decomposed situations significantly decrease the efficiency of the procedure.

The fact of over decomposition (when excess chemical stabilizes the emulsion or forms new emulsion types) is often very difficult to recognize during the industrial process.

Generally, various mechanisms are considered in the case of demulsifiers, however, it is obvious that the demulsifier must reach the surface of the emulsified droplet and the surrounding liquid layer. Demulsifiers destroy the interfacial layer between oil and water consisted of natural surfactants found in crude oils, thereby facilitate the coalescence of droplets and settlement of water to the bottom of the container, as well as floating up of the crude oil.

The type of demulsifiers used generally depends on the field conditions, oil-water ratio and type of crude oil. Conventional demulsifiers are usually based on the following types of chemicals: polyglicols and polyglycol esters, ethoxylated alcohols and amines, ethoxylated vaxes, ethoxylated phenyl-formaldehyde vaxes, ethoxylated nonyl-phenols, polyhydrated alcohols.

Microbial Methods

The use of specific bacteria opened a new chapter in demulsification. Bacteria added into crude oil emulsions within surface devices can facilitate the phase separation. Cairns et al. developed a model for the destabilization of emulsions [W. L. Cairns., D. G. Cooper, N. Kosaric, Bacteria-Induced Demulsification, in: Microbial Enhanced Oil Recovery, pp. 106-113, eds.: Zajic J. E, D. C. Cooper, T. R. Jack, N. Kosaric, Pennwell Publishing, Tulsa (1983); W. L Cairns, et al., Characterization of Nocordia amarae as a Potent Biological Coalescing Agent of Water-Oil Emulsions, Applied and Environmental Microbiology, pp. 362-366 (1982)]. Research was done on model emulsions. In this model, bacterial cells serve as humidifying, connecting bridges between droplet dispersed in a continuous phase. Bacteria in contact with the emulsified droplets break-up the interfacial layer, consequently the droplets coalesce. The effect of the bacteria may result from the similar surface hydrophobicity of the cell wall and the interfacial layer. This model can be extended with other demulsification effects resulted from various metabolites (natural surfactants, organic acids, alcohols, etc.) Surfactants facilitate demulsification due to their effect to increase adhesion between the bacterial cells and the interfacial layer stabilizing the droplets.

Very low bacterial concentration is used in almost all field application compared to the amount of water-in-oil or oil-in-water emulsions, therefore the concentration of natural surfactants produced by the bacteria is not sufficient for the maintenance of the film. Consequently, it is improbable that the bacterial treatment will increase the stability of the emulsion [Broshures of Micro-Bac International, Inc., USA (1990)]. The concentration of microorganisms used probably will not enable the formation of a self-sustaining bacterium-carrying film, either. There is no mentioning of comprehensive combination with chemical methods.

Similar solution is provided by Micro Well Services (http://wwvvw.micro-well.com) in Paragone™. Although the procedure uses microorganisms for cleaning and demulsification of oil-wells, the solution prescribes repeated treatments to achieve the desired effect. They mention the surfactant production of the bacteria used, as well as the formation of polysaccharide layer inside the pipes, however, no detailed teaching is given for the preparation of a long-lasting, self-sustaining film for carrying the bacteria. Prescribing repeated treatments is definitely a contra-indication with respect to the possibility of stable bacterial colonization. There is no teaching for the use of additives to increase viscosity or dissolution agents.

Thus, there is a need for the improvement of methods having different efficacy for preventing the formation of emulsions in crude-oil producing wells, as well as for breaking up emulsions already formed in order to improve the efficiency of oil production and decrease costs.

It was surprisingly found that by a specific combination of chemical and microbiological methods a significant improvement can be achieved in the demulsification and prevention of emulsions formed in the oil producing wells, flow line and pipelines.

Definitions

The term “water-in-oil” emulsion means a coarse-disperse system in which water droplets >1 μm in diameter are dispersed in a continuous crude oil phase.

In an “oil/in/water” emulsion, the water is the continuous phase, and the crude oil is dispersed.

“Tenside” means any surfactant.

The term “industrial surfactant” is meant to be a product containing asymmetrically polar molecules, which are used on industrial scale.

A “material increasing viscosity” defined herein as an organic or inorganic compound that changes the viscosity and Theological properties of a liquid having Newtonian Theological properties when admixed therewith, producing a colloid system having soft, plastic rheological properties.

The term “microorganism” is meant herein as a living organism, either of mono or multicellular structure or without and cellular structure, preferebly monocellular organisms, which belong to the scope of microbiology. “Microorganisms” are preferebly algae, in particular blue algae; bacteria and fungi.

A “microorganism strain” is a pure culture of microorganisms started from a single cell, preferebly a culture of a given species maintained or maintainably by regular subculturing.

The term “film carrying bacteria” or “bacterium-carrying film” is defined herein as a continuous film in the physicochemical sense, which binds well to metal surfaces soiled with hydrocarbons, and at the same time provides for the living conditions for the bacteria used. Preferably, the viable bacterial layer forms a part of the film.

### SUMMARY OF THE INVENTION

In the method according to the invention, microorganisms selected for tenside-production and oil-degradation are used, and a “film carrying bacteria” is formed in the treated pipes by the use of a combination of appropriate additives. This film provides the living and operating conditions for the microbes. In addition to this, the additives of the microorganisms used for the inhibition of the formation of emulsions are supplemented with tensides and materials increasing viscosity, which, in part or on the whole, are biodegradable. These are advantageous from a technological standpoint, and on the other hand, provide a retard carbon source for the microbes, therefore their use can provide the approach and attachment of microbes to the inner metal surfaces of the pipes for a longer period of time, and can provide for the living conditions thereof. It was especially surprising to find that the combination of the additives according to the invention enables the long-standing survival of a self-sustaining bacterial layer on the wall of the pipe. This, in contrast to the above detailed prior art techniques, enables the continuous prevention of formation of an emulsion in the crude oil in contact with the surface. Without restricting the scope of the invention by theory, long-lasting survival of the bacterial layer on the surfaces in contact with crude oil might be due to the combined effects according to the invention, of the additives used. In this respect, it is especially noteworthy that by the addition of materials increasing viscosity to the film carrying bacteria, the inherently viscous precipitates can be broken up, therefore decrease of their viscosity is achieved.

In a further embodiment of the method according to the invention, microorganisms selected for tenside-production and oil-degradation are used together with a combination of appropriate additives, the presence of which provides the living and operating conditions for the microorganisms. According to this embodiment, the formation of the bacterium-carrying film is not necessary, but the high effectiveness of appropriately selected microorganism strains is essential to achieve the desired effect, i.e. the breaking up of emulsions. When carrying out this embodiment, the additives of the microorganisms used for the inhibition of the formation of emulsions are also supplemented with tensides and materials increasing viscosity, which, in part or on the whole, are biodegradable. This way, these materials provide a retard carbon source for the microbes, therefore their use can provide for the living conditions of the microorganisms.

Accordingly, the present invention relates to a method for preventing the formation of oil-in-water and/or water-in-oil emulsions and/or for breaking up emulsions already formed, comprising (a) adding tensides, materials for increasing viscosity, industrial surfactants, and microorganisms capable of breaking down crude oil components or derivatives and producing at least one type of tenside, to the emulsion already formed or into the device containing the crude oil in which the formation of the emulsion to be prevented, optionally together with additives required for the reproduction of said microorganisms;
b) providing an appropriate temperature for the microorganisms after the addition of the materials in step a);
c) allowing the microorganisms to reproduce and act for a predetermined period of time;
d) checking the results of the treatment; and
e) optionally repeating steps (a) to (d) at least once more, preferably at least three more times.

In a preferred embodiment, the invention relates to a method wherein the microorganisms and additives are used at the same time in the form of an aqueous suspension.

In another preferred embodiment, the invention relates to a method wherein the suspension of microorganisms contains 10⁶-10¹² CFU/liter, preferably 10⁷-10¹¹ CFU/liter, more preferably 10⁸-10⁹ CFU/liter. According to the method of the invention, the volume of the suspension is 100-1000 liter/100 m pipe-length or 50 m³ product, preferably 300-800 liter/100 m pipe-length or 50 m³ product, more preferably 500-600 liter/100 m pipe-length or 50 m³ product.

In an especially preferred embodiment, the volume of the industrial surfactants is 1-10 liter/100 m pipe-length or 50 m³ product, preferably 1-5 liter/100 m pipe-length or 50 m³ product.

The present invention further relates to a method for preventing the formation of emulsions, wherein in step d) the results of the treatment are checked by confirming the presence of a film on the surface in contact with the crude oil which provides for the living conditions of the said microorganisms and contains the said microorganisms, and optionally steps a) to d) are repeated by changing the parameters, preferably by changing the amount of the tenside or material capable increasing viscosity, or by varying the reproduction time of microorganisms.

In a preferred embodiment, the method is used for preventing the formation of emulsions in production pipes of oil-producing wells.

In a further preferred embodiment, the microorganisms are allowed to reproduce and act for 1 to 15 days, preferably 6 to 8 days, while the pipes are kept closed.

In another preferred embodiment, the method is carried out in a production oil well, and the temperature of the well is determined by the geological conditions.

In yet another embodiment, as a step of the method, the surface of the pipe can/must be cleaned by mechanical means to remove asphaltene-paraffin-vax precipitates.

The invention relates to a method wherein the results of the treatment are checked by pilot test and/or by confirming the phase separation and/or by evaluating the physico-chemical properties, preferably the decrease of viscosity of an oil sample and/or evaluating the drop-size of the asphaltene-paraffin-vax precipitates in an oil-sample by microscopy.

The invention also relates to a method wherein emulsions already formed in surface producing facilities of oil wells, or highly stable middlephase formed in demulsification facilities of oil producing technologies are broken up.

According to a preferred embodiment, the microorganisms are allowed to reproduce and act for 1 to 15 days, preferably 5 to 8 days, while the devices are kept closed, and the temperature is kept between 20 to 60° C., preferably between 40 to 50° C.

In another preferred embodiment, the results of the treatment are checked by evaluating the physico-chemical properties, preferably the decrease of viscosity of an oil- and/or water-sample, and/or by evaluating the drop-size of the asphaltene-paraffin-vax precipitates in an oil-sample by microscopy.

In a further preferred embodiment, the surfactant is selected from the group consisting of polyoxyethylene ethers or esters and mixtures thereof, preferably Tween 80.

In a more preferred embodiment of the method, xanthan is used as a material for increasing viscosity.

The invention further relates to the use of a microorganism capable of breaking down crude oil components or derivatives and producing at least one type of tenside for preventing of the formation of oil-in-water and/or water-in-oil emulsions and/or for breaking up emulsions already formed.

In a preferred embodiment, the prevention of formation of emulsions is carried out by the formation of a bacterium-carrying film on the surfaces in contact with the crude oil.

In a more preferred embodiment, the microorganism is a strain belonging to the Bacillus subtilis species, the Bacillus cereus species, the Pseudomonas genus or the Xanthomonas genus, and is preferably facultative anaerobic.

In an especially preferred embodiment, the microorganism strain is obtainable by the following selection method:
i) applying a film comprising mineral oil component(s) or derivative(s) to a minimal medium lacking carbon source,
ii) inoculating this medium with a sample comprising a mixture of microorganisms, said sample being obtained from an oil pollution, and incubating the medium after inoculation at least till detectable microorganism colonies are formed; if the formation of colonies does not occur within an arbitrarily defined time period step i) and present step ii) are repeated,
iii) decomposing activities of the microorganism from the colonies formed are tested at the surroundings of the colonies, and
iv) tenside producing abilities of the decomposing microorganisms obtained from the colonies are checked.

The microorganism is selected form the group consisting strains NCAIM (P) B 1304, NCAIM (P) B 1305, NCAIM (P) B 1306, NCAIM (P) B 1307 and NCAIM (P) B 1308 deposited on Apr. 17, 2002 at NCAIM, or any strain derived therefrom, and preferably is a strain that is genetically modified, more preferably modified by the insertion of a DNA fragment with a known sequence as a marker.

The invention further relates to a kit for preventing the formation of oil-in-water and/or water-in-oil emulsions and/or for breaking up emulsions already formed, comprising a microorganism useful in the method of the invention, further comprising instructions to carry out the method of the invention.

In a preferred embodiment, the kit according to the invention comprises one or more of the microorganisms defined hereinbefore and additive(s) necessary for the reproduction thereof.

In a further preferred embodiment the kit also comprises a surfactant and/or a material for increasing viscosity.

### BRIEF DESCRIPTION OF THE FIGURES

In FIG. 1, colonies of isolated bacteria can be seen streaked (inoculated) on a thin film of pollutant in three Petri-dishes. It can be observed that the pollutants are decomposed or converted surrounding the colonies. This can be seen as clearing or discoloration around the colonies. Whether we want to characterize the activity of decomposition, we can measure the width (diameter) of the cleared up (discolorated) band.

In FIG. 2 the ability of the acquired microorganism strains (phyla) to produce tensids is examined. With the hydrophilic—hydrophobic drop test one can observe the difference between spreading and non-wetting drops.

FIG. 3 shows the effect of several microorganism strains—described using chromatography—on the hydrocarbon content of a paraffin sample (for V. see FIG. 3a, for II. see FIG. 3b) after one week of incubation. In the bar chart the ratio (expressed in percentage) the area below the curve characteristic of the undecomposed sample can be seen in the ratio of the area below the curve of the whole undecomposed mass. The marks on the horizontal axis mean the following microorganism strains.

| | | |
|---|---|---|
| Ref I | Hegrem* | |
| Ref II | Hegboost* | |
| A | MOL-2 | NCAIM (P) B 1304 |
| B | MOL-32 | NCAIM (P) B 1305 |
| C | MOL-51 | NCAIM (P) B 1306 |
| D | MOL-66 | NCAIM (P) B 1307 |
| E | MOL-107 | NCAIM (P) B 1308 |
| F | MOL-113 | A Pseudomonas sp. strain isolated by the inventors |

*commercialized by Oil Cleaning Bio-Products Ltd. P.O. Box 46, Royston, Hertfordshire SG8 9PD U.K., see also the product descriptions and the home page: www.ocbp.co.uk.

FIG. 4 shows the flow characteristics of oil-samples from the oil-well designated Battonya-Kelet-51, before the treatment for asphaltene-paraffin-vax precipitates, and after three treatments, respectively.

FIGS. 5a and 5b show the microscopy of the asphaltene-paraffin-vax precipitates in the emulsion-sample from the oil-well Battonya-Kelet-83, before and after treatment, respectively.

FIG. 6 shows the stability of the emulsion produced from the oil-well Battonya-Kelet-83, before the treatment, and after three treatments, respectively.

FIGS. 7a and 7b show the emulsion produced from the oil-wells in the Rúzsa region, before treatment, and after different types of treatments, as well as the samples before and after shaking.

### DETAILED DESCRIPTION OF THE INVENTION

According to the invention, microorganisms capable of solubilizing of emulsions are used, which are optionally resistant thereto. The microbes capable of destroying and/or inhibiting emulsions can be isolated in advance from production wells, pipelines or crude oil containers. On the other hand, commercially available microorganisms, which are capable of decomposing paraffines, vaxes and asphaltenes and/or producing tensides, as well as genetically modified forms thereof can be used. The microbes used, with respect of their thermal needs, can be normal-intermediate (mesophil) or favoring a temperature higher than usual (thermophil). With respect of their oxygen needs, anaerobic and facultative anaerobic microorganisms can be used. Furthermore, the microbes used for the present invention produce certain materials (enzymes and/or tensides) in situ, which in turn capable of modifying the colloidal structure of the emulsions, and therefore breaking up them and/or preventing their formation. In certain cases there can be a demand that the microorganisms used for demulsification be apathogenic, in other words they shouldn't cause neither plant, nor animal, nor human diseases. In other cases even microorganisms capable of causing diseases can be used, if later they die. The microorganisms suitable for carrying out the technology of the invention, as mentioned hereinbefore, are commercially available, or alternatively can be some of the Pseudomonas sp., Xanthomonsas sp. strains isolated by the present inventors.

Such microorganism strains suitable for the present invention can be prepared by the use of standard selection techniques known to the person skilled in the art, by culturing on appropriate selection medium, and selecting the strains showing the desired growth properties. Preferably, known microorganism(s), capable of decomposition, washing-off and inhibition and removal of the formation of mixtures of hydrocarbons (optionally resistant to said mixtures) can be used as starting material for the selection. Alternatively, bacteria can be cultured from oil production wells, from crude oils and oil containers, possibly from soils contaminated with oil, and then these bacteria can be further selected based on their effects on large molecular weight asphaltene-paraffin-vax precipitates. Such selection method is disclosed in the PO₂₀₃₃₉₄ Hungarian patent application, the disclosure of which is incorporated herein be reference.

In a preferred embodiment, the microorganism suitable for the method according to the invention can be selected as follows:
i) applying a film comprising the mineral oil component(s) or derivative(s) to a minimal medium lacking carbon source,
ii) inoculating this medium with a sample comprising a mixture of microorganisms said sample being obtained from an oil pollution, and incubating the medium after inoculation at least till detectable microorganism colonies are formed; if the formation of colonies does not occur within an arbitrarily defined time period step i) and present step ii) are repeated,
iii) decomposing activities of the microorganism from the colonies formed are tested at the surroundings of the colonies, and
iv) tenside producing abilities of the decomposing microorganisms obtained from the colonies are checked.

Preferably, the microorganism is a facultative anaerobic which is obtained by the above method by using minimal medium comprising materials facilitating anoxic respiration, preferably electron acceptors and/or oxigen sources—in particular one or more of the following: Ti-compounds, Mn-compounds, nitrite, nitrate, phosphate, pyrophosphate ions or their salts, and preferably the incubation is carried out at least partly under anaerobic conditions.

The decomposing activity preferably is assessed by assaying the pollutant concentration of samples taken from the close surround/immediate vicinity of the colonies and/or on the basis of the diameter of the decomposed area. As a decomposing activity e.g. paraffin decomposing activity can be assayed or an enzyme activity for decomposing typical mineral oil pollutions, preferably by sampling, solvent extraction then by gas chromatography.

In a preferred embodiment, tenside producing ability of the microorganisms from the colonies obtained can be studied by e.g. a hydrophobic-hydrophilic drop test.

If microorganisms are isolated from the environment, so called sterile “solid minimal cultural-media” or preferably “silicagel solid culture-media” is used (for example in Petri-dishes).

Whether we isolate microorganisms capable of aerobic and anoxic activity it is advised to use culture-media containing nitrogen, sulphur, phosphorous salts and agar-agar, preferably sterile silicagel solid culture-media.

It is important to administer the specific hydrophobic pollutant or other hydrophobic compounds (hydrocarbons, crude oil, or its components and their derivatives) to decompose, dissolved in some kind of solvent, for instance a certain volatile organic solvent (alcohol, acetone, ether), preferably in pentane, hexane, or in methyl-benzene in the form of a thin film. Then the selected microorganisms from a fresh culture should be streaked onto this pollution layer, afterwards it should be incubated in the appropriate conditions for the strains (psychrophil, mesophil, thermophil, and aerobic, or anaerobic). After a certain time the microorganisms resistant to the pollutant and are able to decompose it will form colonies usually consistent or showing characteristic morphology or pigmentation.

The microorganisms release enzymes into the area around the colonies, which are capable of decomposing the hydrophobic compounds such as hydrocarbons, and tensides are released also.

The enzyme production can be characterized by the width of the band (clearing up or discoloration) surrounding the colonies. This characterizes the intensity of the enzyme production mainly (FIG. 1). The produced enzyme activity can be determined by taking samples from the surrounding area of the colonies and we determine the composition of the pollutant by the means of gas chromatography. The microorganisms showing the highest enzyme activity are then selected.

The microorganisms producing tensides can be selected according to the hydrophilic-hydrophobic examination (for instance by water drops then by paraffin drops; see FIG. 2).

Depending on the conditions of the selection of the microorganisms we can acquire information concerning their essential conditions besides their activity of decomposition. Thus microorganisms used for bioremediation can be ones that prefer cold (psychrophilic), the ones that prefer medium temperature (mesophilic), or the ones that prefer temperature above normal (thermophilic).

Using the above-mentioned selection method, the present inventors isolated Pseudomonas sp. and Xanthomonas sp. microorganisms from oil polluted soils, the following of which were deposited on Apr. 17, 2002 at the National Collection of Agricultural and Industrial Microorganisms (1118 Budapest, Somlói út 14-16) according to the Budapest Treaty:

| MOL-number | Deposition number |
|---|---|
| MOL-2 | NCAIM (P) B 1304 |
| MOL-32 | NCAIM (P) B 1305 |
| MOL-51 | NCAIM (P) B 1306 |
| MOL-66 | NCAIM (P) B 1307 |
| MOL-107 | NCAIM (P) B 1308 |

Microorganisms can be genetically enhanced, favorably carrying DNA fragment—of which the sequence is known—ligated into its' genomes as a marker.

In preferred embodiments of the present invention, the materials used binds well to metal surfaces soiled with hydrocarbons. Due to this binding, a thin, continuous “film carrying-bacteria” is formed on the contaminated metal surfaces from the additives used. This bacterium-carrying film provides the living conditions for the bacteria used. It is noted again that a viable, reproducing bacterial layer can be formed on the soiled surface of the pipe in the inventive method. This bacterial layer localizes the effects described hereinbefore in the section on microbial treatments, and this focused effect allows an improved, more effective means for the prevention of formation of emulsions.

In further preferred embodiments, the formation of emulsions are prevented inside of pipes of oil-wells, flow line thereof, or in oil pipelines by the use of the method according to the invention.

The bacterium-carrying film of the invention has the advantageous property of stability against wash-off by the flowing mixture of hydrocarbons. This is essential for the long-standing maintenance of viable bacterial population necessary for preventing the formation of emulsions in the treated oil wells, pipelines, etc., providing a self-sustaining demulsification mechanism.

In a preferred embodiment, the invention relates to a method wherein the microorganisms and additives are added into the target site at the same time in the form of an aqueous suspension. The polymer materials forming the film are capable of maintaining most of the microorganisms on the surface of the pipe in the form of a suspension, not interfering with the reproduction of said microorganisms and with the production of metabolites. Thus, the bacterial suspension introduced by the treatment remains stably on the surface of the pipe, and due to its viability and metabolism, it continuously provides the inhibition of the formation of emulsions.

The effectiveness of demulsification can be characterized by the kinetics of phase separation, and by the variations of separation with respect to the temperature, quality and quantity of additives. If the decrease in stability of the emulsion is not accompanied with a definite phase separation, the decrease can be characteristic in the viscosity of the well-stream, or the increase in the drop-size.

The aerobic or facultative anaerobic strains belonging to the species Bacillus subtilis, or to the genuses Pseudomonas or Xanthomonas produce Surfactin and Rhamnolipid type tensides. The concentration of these can vary between 10 to 100 mg/l, depending on the composition of the medium, temperature and bacterium count per volume unit (which is in our case is 10⁷-10⁸ cell/ml). The critical micellar concentration of aqueous solutions of Rhamnolipid and Surfactin is C_{M}=20 and 11 mg/l, respectively [Bognolo, G., Biosurfactants as emulsifying agents for hydrocarbons, Colloids and Surfaces, A 52, 41.52 (1999)]. Based on the production rate for the tensides on the wall of the production pipe, and the flow rate and water-content of the well-stream, the actual concentration of the tensides can be calculated. Even if this concentration is below the CM value necessary for the stabilization of the emulsion, it may definitely be enough to facilitate the interaction between the bacteria and the interfacial layer of emulsified droplets, thus decreasing the stability of the emulsion. The choice of any given bacterial strain can be critical with respect to their tenside production, as well as their effect can be the stabilization of the emulsion rather than its destabiliztion, depending on the nature of the tenside produced.

The invention also relates to a method wherein the suspension of microorganisms contains 10⁶ to 10¹² CFU/liter, preferably 10⁷ to 10¹¹ CFU/liter, more preferably 10⁸ to 10⁹ CFU/liter. According to this method, the volume of the suspension is 100 to 1000 liter/100 m pipe-length, preferably 300 to 800 liter/100 m pipe-length, more preferably 500 to 600 liter/100 m pipe-length.

In these preferred embodiments, the metabolites produced by the reproducing bacteria in the bacterium-carrying film formed from the starting materials used, and the reproducing bacteria themselves enter the flow of the hydrocarbons. These mobilized bacteria and metabolites, preferably having tenside and detergent activity, provide further means for the regeneration of the bacterium-carrying film. This way the film will also be extended.

The film carrying the bacteria, together with the bacteria therein and attached to the wall of the pipes, will hydrophylize the metal surface. This effect is facilitated by the additive components having surface activity, which are not interfering with the viability of the microorganisms. The preferred surfactants are selected from the group consisting of octil- or nonilphenoxy-polyethoxy ethanols (for example from the commercially available Triton™ series), polyoxyethylene sorbitan esters (Tween™ series) and the polyoxyethylene ethers or esters of the general formula (I):
HO(CH₂CH₂O)ₙ-A-R (I)
wherein n is an integer between 1 and 50, A is chemical bond or —C(O)— group, R is C₁₋₅₀ alkyl or phenyl-C₁₋₅₀ alkyl; or a combination of two or more of the above. In a preferred embodiment the surfactant is selected from the group consisting of polyoxyethylene ethers or esters and mixtures thereof, preferably Tween 80.

The main assurance for the stability of the bacterium-carrying film is the use of materials increasing viscosity, to increase the relative viscosity of the additive mixture realtive to water. These additives are preferably macromolecular compounds. The use of said compounds allows and strengthens the attachment of the bacterium-carrying film and the bacteria therein to the inner surface of the pipe, and maintains the bacterium-carrying film on the surface. Non limiting examples of such macromolecular components according to the invention are synthetic polymers, such as Carbolpol, Supramil, or natural polymers, such as xanthan, and other water soluble macromolecules, such as starch, cellulose derivatives, and the like. Both the synthetic and natural water-soluble polymers (which serve as nutrient for the bacteria) facilitate the formation of the bio-film (which is about around one tenth of a millimeter thick) on the wall of the pipe, or in the containers. The natural polymers will provide this effect for only a short time, however. The non-biodegradable polymers can achieve long-lasting effects. If the amount of the polymers determined correctly in the production pipe or in the container, the excess of those entering the aqueous phase of the emulsion will not cause the inhibition of the phase separation. According to an especially advantageous embodiment, the material increasing viscosity is xanthan. The additives are used in a ratio of 1:3 to 3:1, depending on the amount of the precipitates preventing the adsorption thereof.

The additives used to form the film carrying the bacteria may contain further components, for example dissolution agents, such as dimethyl sulfoxide, cellosolv, methyl-cellosolv, and the like. The synthetic acrylamide-based polymers and dissolution agents contribute significantly to the long-lasting effects.

Additives to increase the viability, reproduction and/or activity of the bacteria can be preferably introduced into the system, which can be admixed to the film carrying the bacteria without decreasing its effectiveness. These additives can provide the nutrients for the microorganisms used, such as provide the necessary moisture, electron acceptors, macro and micro elements (materials to provide the necessary carbon, nitrogen, phosphorus, sulphur, etc.) in order to effectively inhibit the formation of emulsions or prevent those in the pipes treated.

Furthermore, the activity of facultative anaerobic microbes can be enhanced by the use of electron acceptors to allow anoxic respiration, such as nitrite (NO₂⁻), nitrate (NO₃⁻), phosphate (PO₄³⁻) or sulphate (SO₄²⁻) and/or ferri salts. In addition, inorganic salts of other compounds, which also help anoxic respiration (NO₂, NO₃, PO₃, PO₄, P₂O₄, P₂O₇, ClO₄, BO₄, B₂O₇), or even organic compounds (dehydro ascorbate, alpha keto-glutarate, acetic aldehyde, pyruvate, oxalic acetate, fumarate, humin acids, etc.) can be used [Chih-Jen Lu et al., The effect of electron acceptors on the nitrate utilization efficiency in groundwaters, in Hydrocarbon Bioremediation, pages 469-474, editors: R. E. Hinchee B. C. et al., Lewis Publisher, Boca Raton, Fla.].

Preferred additives to be used according to the invention are the following:
(i) carbon sources, preferably glucose, saccharose, molasses, glycerol, acetate, xanthan, etc.;
(ii) nitrogen sources, preferably peptone, essential amino acids, NH₄, NO₂, NO₃ salts, etc.;
(iii) phosphorous sources, preferably PO₄, P₂O₅, P₂O₇, etc. salts;
(iv) sulphur sources, preferably sulphate, pirosulphate ions or their salts.

In the method according to the invention, the microorganisms are allowed to reproduce and act for 1 to 15 days, preferably 6 to 8 days, while the pipes/containers are kept closed. In case when there is a possibility to modulate the temperature of the surface, container or pipeline, it should be set to a temperature which allows for the reproduction and activity of the microorganisms, preferably near to the optimal temperature thereof. The temperature used is typically between 20 to 98° C., preferably between 40 to 80° C., and in the case of moderately thermophilic bacteria, preferably between 50 to 70° C., more preferably around 60° C. The methods of the invention are preferably carried out by using the microorganism defined in the present specification.

The present invention further relates to the use of a microorganism capable of breaking down crude oil components or derivatives and producing at least one type of tenside for preventing the formation of emulsions and/or for breaking up emulsions already formed on surfaces in contact with crude oil. In certain specific embodiments, this effect is achieved by the formation of a stable bacterium-carrying film.

In a preferred embodiment, the invention relates to the use of a microorganism which is a strain belonging to the Bacillus subtilis species, the Bacillus cereus species, the Pseudomonas genus or the Xanthomonas genus, and preferably facultative anaerobic.

It is an especially preferred use wherein the microorganism is selected form the group consisting strains NCAIM (P) B 1304, NCAIM (P) B 1305, NCAIM (P) B 1306, NCAIM (P) B 1307 and NCAIM (P) B 1308 deposited on Apr. 17, 2002 at NCAIM or any strain derived therefrom. The strain can be genetically modified, preferably modified by the insertion of a DNA fragment with a known sequence as a marker.

In further embodiments, the invention relates to a kit for preventing the formation of oil-in-water and/or water-in-oil emulsions and/or for breaking up emulsions already formed on surfaces in contact with crude oil in pipelines, comprising a microorganism useful in the method of the invention, further comprising instructions to carry out the method of the invention.

The invention further relates to a kit comprising one or more of the microorganisms defined hereinbefore and additive(s) necessary for the reproduction thereof. In a preferred embodiment the kit further comprises a surfactant and/or a material for increasing viscosity.

The present invention is described in more detail by the following proposed preferred embodiments.

### Proposed Embodiment I

I.) According to the preventive in situ method of the present invention, the microorganisms selected for crude oil decomposition and/or tenside production and/or demulsification are introduced in high (10⁶ to 10¹² CFU per liter, preferably 10⁷ to 10¹¹ CFU per liter, more preferably 10⁸ to 10⁹ CFU per liter) amount in high (100 to 1000 liter per 100 meter pipe-length, preferably 300 to 800 liter per 100 meter pipe-length, more preferably 500 to 600 liter per 100 meter pipe-length) volume with 1 to 5 liter industrial surfactant mixture added into the production pipe to be treated, which was previously mechanically cleaned from the asphaltene-paraffin-vax precipitates by the use of scraper.

II.) After the treatment, a desired temperature is provided, optimally between 20 and 50° C.

III.) The producing pipe is kept closed for a desired time, for 1 to 15 days, preferably for 6 to 8 days.

IV.) After this, the results of the treatment is checked by a few days of pilot test and/or by the physico-chemical and microscopic evaluation of an oil-sample.

V.) Steps I. to III. are optionally repeated at least once more, preferably at least three more times, if desired.

### Proposed Embodiment II

I.) According to the preventive in situ method of the present invention, the microorganisms selected for crude oil decomposition and/or tenside production and/or demulsification are introduced in high (10⁶ to 10¹² CFU per liter, preferably 10⁷ to loll CFU per liter, more preferably 10⁸ to 10⁹ CFU per liter) amount in high (100 to 1000 liter per 100 meter pipe-length, preferably 300 to 800 liter per 100 meter pipe-length, more preferably 500 to 600 liter per 100 meter pipe-length) volume with 1 to 5 liter industrial surfactant mixture added into the flow line of oil well, collecting container or demulsification container to be treated under flowing conditions.

II.) After the treatment, a desired temperature is provided, optimally between 20 and 50° C.

III.) The production is rested for a desired time, for 1 to 7 days, preferably for 2 to 3 days in the collecting or demulsification container.

IV.) After this, the resulted water and oil is removed, while the results of the demulsification is checked by the physico-chemical and microscopic evaluation of an oil- and/or water-sample.

V.) Steps I. to III. are optionally repeated at least once more, preferably at least three more times, if desired.

### Proposed Embodiment III

I.) According to the method of the present invention, the microorganisms selected for crude oil decomposition and/or tenside production and/or demulsification are introduced in high (10⁶ to 10¹² CFU per liter, preferably 10⁷ to 10¹¹ CFU per liter, more preferably 10⁸ to 10⁹ CFU per liter) amount in high (100 to 1000 liter per 50 m³ product, preferably 300 to 800 liter 50 m³ product, more preferably 500 to 600 liter per 50 m³ product) volume with industrial surfactant mixture added into the demulsification container to be treated under flowing or mixing conditions.

II.) After the introduction, a desired temperature is provided, optimally between 40 and 50° C.

III.) The middlephase mixed with the bacterial suspension is rested for a desired time, for 1 to 15 days, preferably 5 to 8 days in the collecting or demulsification container. During this time period, the phase separation is checked by taking samples at 6 to 24 hours intervals.

IV.) After the time period of step III., the whole content of the treated container is pumped into a temporary container, then the so mixed middlephase is pumped back into the original container. The sampling frequency decreased to 1 sample per day.

V.) At day 10 to 20, the heating is discontinued in order to end the mixing by convection, and to speed up the phase separation.

VI.) After this, on day 11 to 21, the resulted water and oil is pumped into two separate containers for further processing, while the results of the separation is checked by the physico-chemical and microscopic evaluation of an oil- and/or water-sample taken from specific outflows.

VII.) After removal of the settling water and floating crude oil, the inorganic solid material at the bottom of the container is removed by physical means.

VIII.) The materials pumped into the two separate containers are heated up again to the optimal temperature, and rested for 1 to 2 days while cooling down, followed by the removal of the settling water and floating crude oil. The inorganic solid material settled eventually to the bottom of the containers is removed again by physical means.

IX.) Steps I. to VIII. are optionally repeated at least once more, preferably at least three more times, if desired.

The invention is further detailed in the following examples.

A. Selection of Microorganism Strains

### EXAMPLE 1

### Cultures on Minimal Medium

Suspensions (1-20%) of samples containing materials of the said precipitates or a component thereof (mineral oil components, paraffins, asphaltenes, maltenes, etc., or derivatives of the mineral oil) are dispersed in physiological salt solution or even in any physiologically useable buffer with a pH 6.5-7.6 were made. Certain dilutions of such suspensions were administered onto the surface of agar-agar minimal culture media, and were incubated on 0 to 80° C. for a desired time, preferably for 12-72 hours. The isolated colonies were selected according to their activity of pollutant decomposition.
Agar-agar minimal culture-media (for 1000 g of distilled water):
0.1 to 3 g preferably 2.5 g Na₂PO₄
0.1 to 3 g preferably 1.5 g KH₂PO₄
0.1 to 3 g preferably 0.5 g (NH₄)₂SO₄
0.01 to 3 g preferably 0.05 g CaCl₂
0.5 to 3 g preferably 2.0 g agar-agar
0.1 to 5 g preferably 1.5 g NaNO₃

It can be seen that the media contains ions promoting anoxic respiration (PO₄³⁻ and its protonated forms, SO₄²⁻, NO₃⁻) in other words it contains electron acceptors, which also allows the selection of aerobic and facultative aerobic microorganisms.

In certain cases the aforementioned media was supplemented with 1 to 50 mL, preferably 10 mL of the following solution (1000 mL):
0.1 to 0.5 g preferably 0.25 g H₃BO₄
0.1 to 1.0 g preferably 0.25 g CoCl
0.1 to 2.0 g preferably 0.25 g CuCl₂
0.05 to 2.0 g preferably 0.25 g FeSO₄
0.01 to 1.0 g preferably 0.025 g MnCl₂
0.01 to 1.0 g preferably 0.025 g NaMoO₄
0.01 to 1.0 g preferably 0.025 g NiCl₂
0.01 to 1.0 g preferably 0.025 g TiCl₄

The metal ions of other oxidative states (for example Ti, Mn, Mo ions) also promote anoxic respiration as redox systems.

### EXAMPLE 2

### Silicagel Culture Media

The microflora of the polluted soil samples can be grown on so called “silicagel minimal culture-media” which is a version of Vinogradszkij type silicagel solid culture media which is supplemented with the compounds mentioned in example 1.

Thermophilic (50 to 80° C.) and extreme thermophilic (80 to 110° C.) microorganisms can be grown and selected on silicagel minimal culture-media.

### EXAMPLE 3

### Examination of the Activity of Pollutant Decomposition

The ability of decomposition of the microorganisms isolated from minimal culture-media can also be examined on such solid media. In this case we administer the hydrophobic pollutant (hydrocarbons, lipoids etc.), dissolved in some kind of solvent, for instance a certain volatile organic solvent (alcohol, acetone, ether), preferably in pentane, hexane, in the form of a thin film. Then the microorganisms to be examined should be streaked onto this pollution layer (FIG. 1).

The colonies are incubated at the desired temperature with the given oxygen concentration, for a desired time, preferably for 12-96 hours, more suitably for 48 hours, then the method should be repeated preferably 2-3 times again with the cultures grown.

The controlled level of oxygen concentration allows us to perform our method in aerobic and anoxic conditions, thus we can isolate microorganisms which show activity in both aerobic and anoxic conditions. During the isolation of such facultative anaerobic microorganisms, part of the growth was done in anoxic conditions, and the media contained compounds that promote anoxic respiration.

When the microorganisms isolated in the aforementioned way were streaked onto the film of pollutant, in the area around the colonies clearing up and discoloration could be observed showing that the pollutant was either converted, or decomposed (FIG. 1).

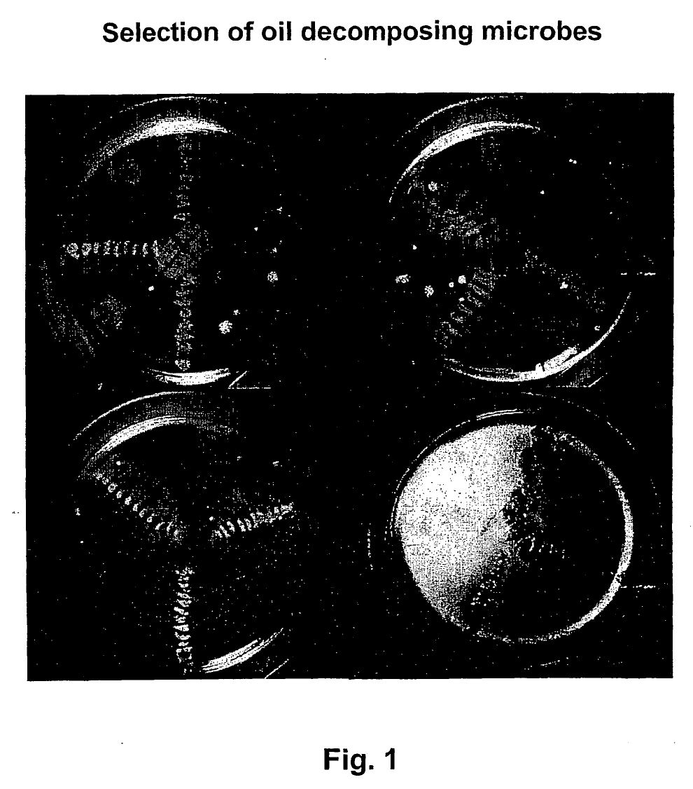

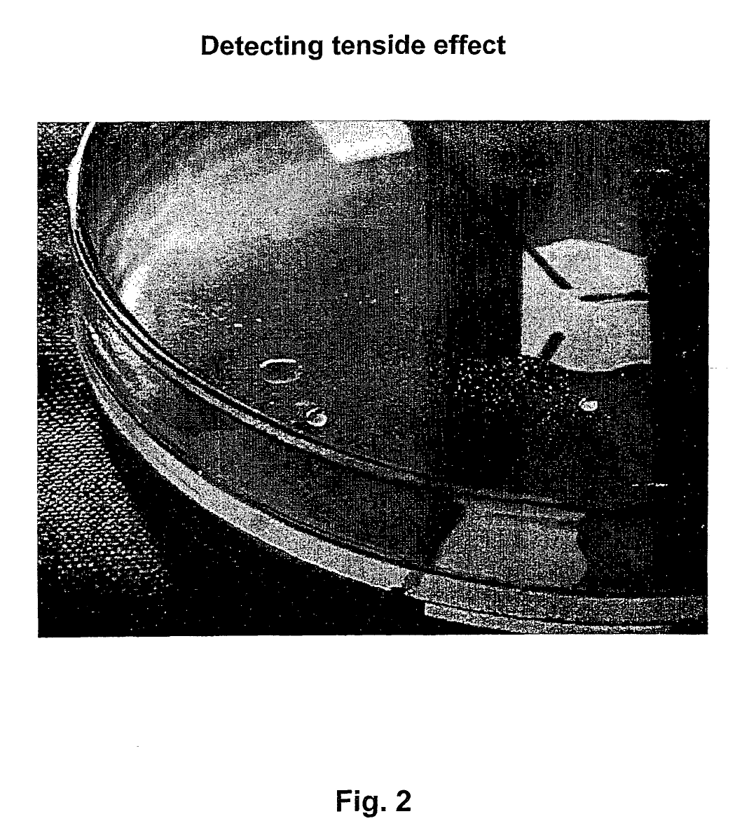

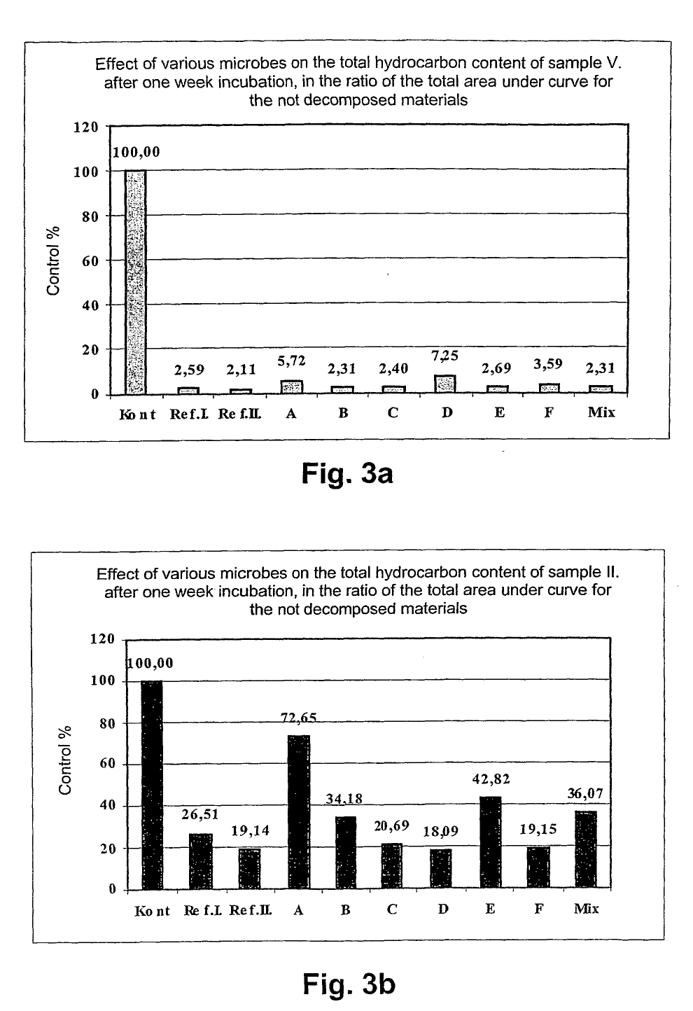

Below we will introduce how we examined the effectiveness of decomposition, the ratio of pollutants decomposed after a certain time in the clearing (FIG. 3), thus the selected enzymes' activity was examined. Also we could examine the appearance of other compounds, specifically tensides, during the course of decomposition, which helped the process (FIG. 2). Of course a person skilled in the art can use other protocols in this case.

### EXAMPLE 4

### Examination of the Effect of Microorganisms

Activity of Enzymes of Oil Decomposition

On the surface of 15 mL of minimal agar-agar or minimal silicagel culture-media in a sterile Petri-dish with a 10 cm diameter we administered a thin film of pollutant (crude oil products dissolved in 5% hexane or methyl-benzene solutions). Onto this film with a platinum loop we streaked the microorganisms isolated from a polluted environment (soil, ground water, etc), and grown in liquid media. Then they were incubated under the desired conditions (aerobic, or anaerobic), at the chosen temperature (15 to 20, 30 to 35 or 50 to 85° C.) for the desired time (24-240 hours), up until the microorganisms formed distinguishable colonies. In case we can observe a certain change in the hydrocarbon film (clearing, discoloration) we take samples from these zones, then extract it (hexane, methyl-benzene etc) with a solvent, then we examine the mineral oil product's quantity and its composition with the help of gas chromatography.

The effectiveness the production (also including the viability) of enzymes capable of decomposing oil can be characterized by the width of the zone of clearing. The activity of the enzymes can be followed by the decrease of the quantity of hydrocarbon components of the rock oil products.

The activity of a few of the isolated microorganism strains is compared to other known strains (Table 1, 2). The letters in the tables mean the following:

| | | |
|---|---|---|
| BO-1: | Hegboost* | |
| RO-1: | Hegrem* | |
| A | MOL-2 | NCAIM (P) B 1304 |
| B | MOL-32 | NCAIM (P) B 1305 |
| C | MOL-51 | NCAIM (P) B 1306 |
| D | MOL-66 | NCAIM (P) B 1307 |
| E | MOL-107 | NCAIM (P) B 1308 |
| F | MOL-113 | A Pseudomonas sp. strain isolated by the |
| | | inventors |

*commercialized by Oil Cleaning Bio-Products Ltd. P.O. Box 46, Royston, Hertfordshire SG8 9PD U.K., see also the product descriptions and the home page: www.ocbp.co.uk.

TABLE 1
The effect of bacteria groups on paraffins with
different melting points.

| Sign of | paraffin | | | | |
|---|---|---|---|---|---|
| group | DW 6266 | DW 7580 | DW 5456 | DW 5658 | DW 5052 |
| BO-1^{e} | + | + | + | + | + |
| | 6 | 5 | 6 | 6-8 | 4-7 |
| RO-1^{e} | + | + | ++ | + | ++ |
| | 6 | 6 | 4-11 | 3-6 | 5-12 |
| A^{t} | ++++ | + | +++ | ++++ | +++ |
| | 15-18 | 5-8 | 10-15 | 11-19 | 11-16 |
| B^{t} | +++ | + | +++ | ++++ | +++ |
| | 5-11 | 5-6 | 10-15 | 13-20 | 10-16 |
| C^{t} | +++ | ± | +++ | +++ | +++ |
| | 10-15 | 4 | 14-17 | 14-18 | 11-14 |
| D^{e(t)} | + | + | ++++ | ++++ | + |
| | 5-7 | 4-5 | 10-22 | 10-34 | 4-7 |
| E^{e(t)} | + | +++ | +++ | +++ | +++ |
| | 6-7 | 10-13 | 13-17 | 11-13 | 13-16 |
| F^{e(t)} | ++ | ++ | ++ | ++ | ++ |
| | 9-12 | 6-10 | 7-12 | 4-10 | 7-12 |

^{(t)}-effect of tensides
^{e}-enzyme activity
activity
+ insignificant
++ partial
+++ satisfactory
++++ outstanding
number - the diameter of the decomposed area

TABLE 2
Different precipitated crude oil decomposition with
bacteria groups at 37° C. after 96 hours.

| | | | | 5% asphaltene + Alg |
|---|---|---|---|---|
| Sign | hydrophobic^{x} | asphaltene | maltene | #571 oil |
| BO-1 | + | | + | ++ |
| | 4-7 | 9 | 4-7 | 6-12 |
| RO-1 | + | | + | ++++ |
| | 4-10 | 7 | 4-8 | 15-18 |
| A | + | ++++ | ± | ++++ |
| | 5 | 10-38 | 2 | 22-25 |
| B | + | ++++ | + | ++++ |
| | 4-8 | 14-20 | 4-7 | 34-37 |
| C | + | ++ | ± | ++++ |
| | 4-6 | 7-12 | 2-4 | 25-30 |
| D | + | + | + | ++++ |
| | 3-6 | 4 | 4-8 | 30-35 |
| E | ++++ | + | ++++ | ++++ |
| | 22-25 | 5-7 | 20-25 | 30-35 |
| F | + | + | ++++ | |
| | 4-5 | 4-5 | 10-35 | 20-35 |

t-effect of tensides
e-enzyme activity
activity
+ insignificant
++ partial
+++ satisfactory
++++ outstanding
number - the diameter of the decomposed area

While comparing FIG. 3 with the tables, one can see that the enzyme activity (measured with gas chromatography, i.e. GC) of our isolated strains was a match for the strains known up to date, the effectiveness of decomposition (characterized bye the average width of the area cleared up as a band), considering the pollutant significantly exceeded that of the strains known up to date. With our technology microorganisms specifically selected can be produced and can be used specifically for a pollutant that they decompose the most effectively.

Detection of Tensides Produced with the Help of Hydrophilic-Hydrophobic Drops

We repeat the procedure mentioned in example 4 in case of oil decomposing enzymes, with the exception that in the clearing surrounding the colonies of the chosen microorganisms, under the desired conditions we administer a few drops of distilled water or melted paraffin onto the surface of the media. In the zone containing tensides the drop of distilled water spreads out, while in the area with no clearing up (hydrophobic) it forms a moveable bead like drop. The melted paraffin drop spreads out in a moveable manner in the area with tensides, while it sticks to the hydrophobic zone making its movement impossible (FIG. 2).

The surface critical angle of the drops is measurable, and can even be used to quantitatively describe the production of tensides if fixing other parameters (growth time, drop zone).

B. Treatment of Oil-in-Water Emulsions

### EXAMPLE 5

### Preventive In Situ Treatment of an Oil-Well

The preventive in situ method according to the proposed embodiment I was tested on three production oil-wells: on the in-production wells designated Battonya-Kelet-16, -51 and -83. Prior to the treatment, the production pipes of the wells were deparaffinated by mechanical means, using the scraper technique. The deparaffination was preformed every other week on Battonya-Kelet-16, and at the of the procedure the lubricator had to be slanted for the cleaning of the scraper. Depth of the deparaffination is 350 too 400 m. Oil-well Battonya-Kelet-51 was deparaffinated three times daily, and the lubricator was slanted. The production pipe of the well Battonya-Kelet-83 was deparaffinated twice a week and the kellett a lubrikátorcsövét dönteni in order to deparaffinate the production pipe in the dpeth of 300 to 350 m. All three produced stable emulsions.

During the treatment of these wells, 1000-1200 liter of additives and a mixture of 10¹¹/liter CFU Pseudomonas sp., Xanthomonas sp. microorganisms [in the present example, NCAIM (P) B 1307, NCAIM (P) B 1308] were used in the production wells of 1500 and 2500 m depth, respectively, repeated 3 times, as described in the specification.

The composition of the additives used is shown in Table 3.

TABLE 3
The composition of the treating fluid. Amounts shown
are for 100 liter of treating fluid.

| | | Preferred | |
|---|---|---|---|
| Component | Additive (g) | amount (g) | w/v % |
| Additive/nutrient | | | |
| Glucose | 50-300 | 100 | 0.1 |
| Saccharose | 150-1200 | 620 | 0.62 |
| Peptone | 10-100 | 40 | 0.04 |
| NH₄NO₃ | 20-400 | 140 | 0.14 |
| Na₂HPO₄ | 30-500 | 125 | 0.125 |
| Polar organic solvent | | | |
| DMSO | 60-1000 | 250 | 0.25 |
| Surfactant | | | |
| Tween 80 | 10-100 | 25 | 0.025 |
| Material increasing viscosity | | | |
| Xanthan | 20-400 | 100 | 0.1 |

Results

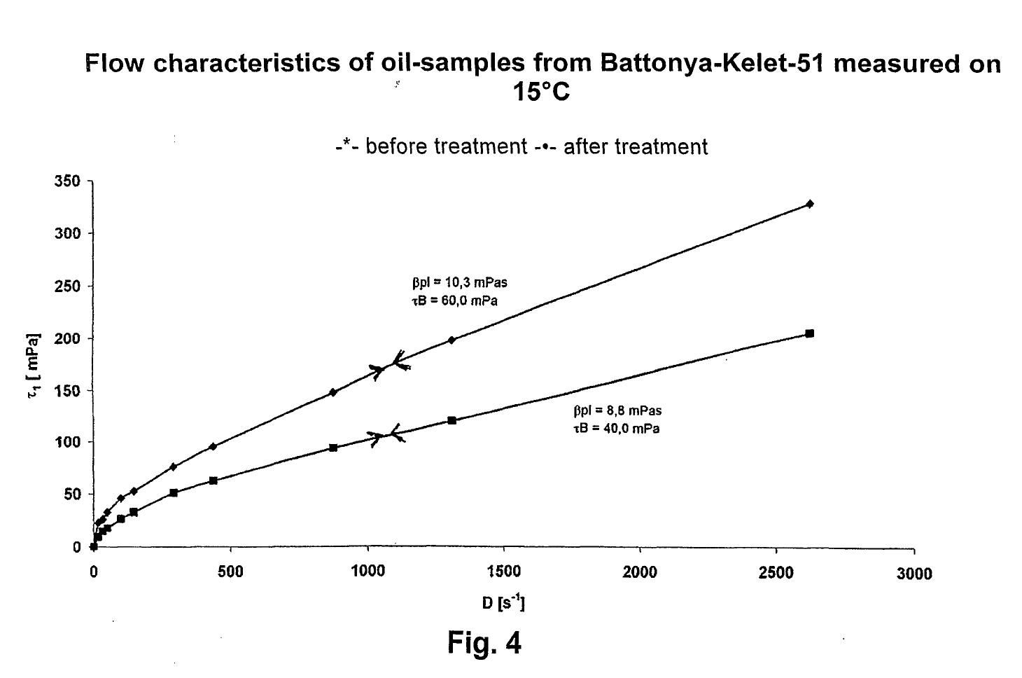

The data presented on FIG. 4 show that the method used resulted in significantly decreased viscosity.

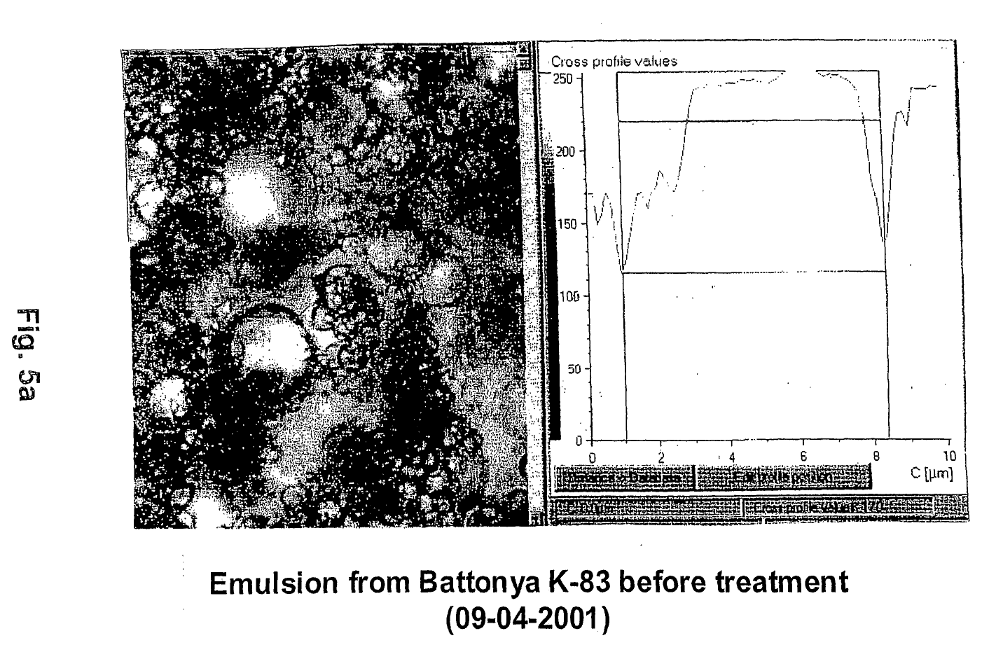

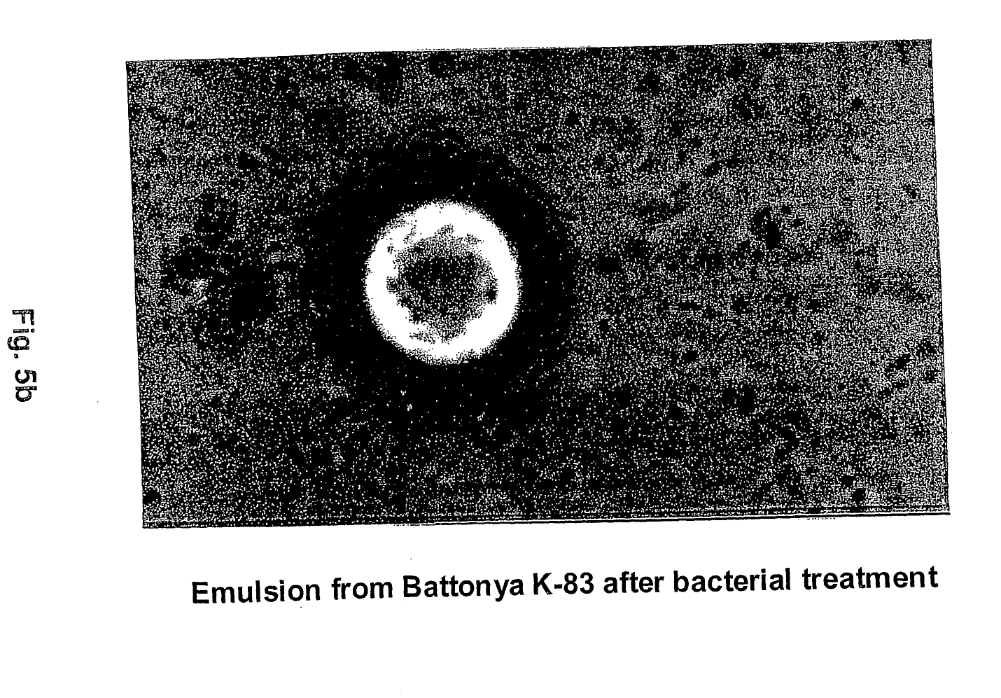

According to FIG. 5, the structure of asphaltene-paraffin-vax precipitates within the flowing phase becomes loose, thereby not capable to form a continuous cross-linked structure on the oil-water interface.

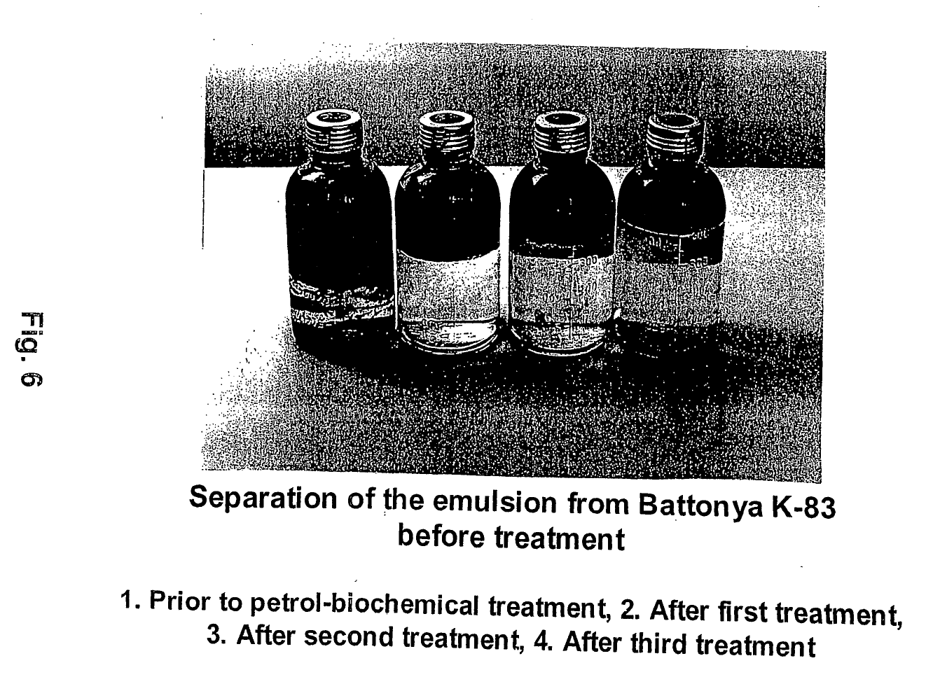

According to the data presented in FIG. 6, the product of Battonya-Kelet-83 separated to clean crude oil and water phases. During the treatments, the foamy intermediate phase formed between the oil and water phases decreases gradually.

The enhanced quality of the emulsions (flow characteristics, demulsification) produced by the oil-producing wells treated with the method presented in this example continuously exists for the past 12-24 months. The stabiliy of the emulsions produced in the Battonya wells changed dramatically. After the treatments, the separation of the emulsion starts immediately upon resting, and the emulsion separates into clean water and oil phases.

### EXAMPLE 6

### Preventive In Situ Treatment of Flow Lines and Gathering Tanks of Oil-Wells

The preventive in situ method according to the proposed embodiment II was tested on the in-production well designated Rúzsa-15. The flow lines and 50 m³ gathering tank were treated.

During these treatments, in the area of the oil-well designated Rúzsa-15, 1000 liter of additives were added into the flow line and another 1000 liter were added into one of the three collecting container (No. 1). The mixture contained 1011 CFU/liter Pseudomonas sp., Xanthomonas sp. microorganisms [in the present example, NCAIM: (P) B 1307, NCAIM (P) B 1308] and 5-5 liter industrial surfactant mixture, given only in a single treatment, as described in the specification. The composition of the additives used is shown in Table 3 above.

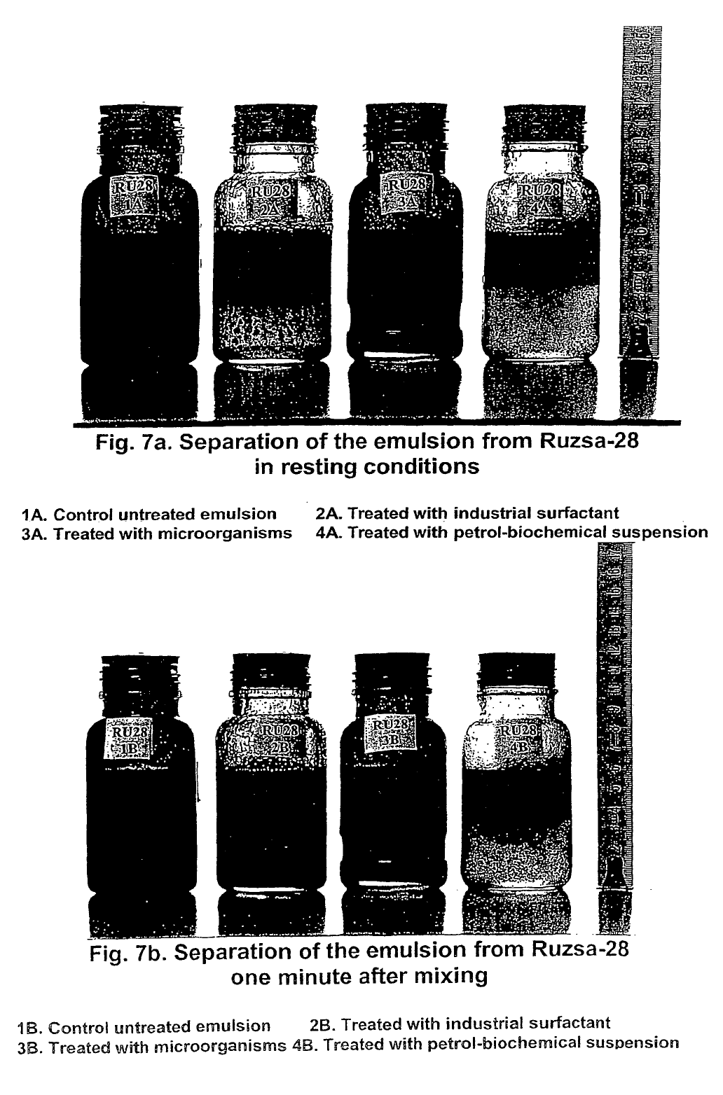

FIGS. 7a and 7b show that phase separation of the production treated by the petrol-biochemical method of the invention was irreversible.

The enhanced quality of the emulsions (flow characteristics, demulsification) produced using the flow line and collecting and demulsification containers treated with the method presented in this example continuously exists for the past 2-4 months. After the introduction of the bacterial suspension, the manageability of the Rúzsa production enhanced significantly. Besides the phase separation, pumping and piping became less problematic.

### EXAMPLE 7

### Treatment of Middlephase

The method according to the proposed embodiment III was tested on the 200 m³ technological container at the main collection facility of MOL Rt located in Kardoskút.

For three years, 138 m³ middlephase was stored, and the demulsification was tried by several times using different traditional methods (heating to 80° C., addition of materials decreasing viscosity and addition of demilsifiers).

During the treatment of the invention, 2000 liter bacterial suspension was admixed with about 50 m³ middlephase from container T-201 in a 60 m³ container, and the whole mixture was pumped back to container T-201.

The temperature of the middlephase was kept around 50° C., and samples were taken at every six hours at the side of the container, through checking valves situated at different heights, and checked the water and bacterium contents thereof.

On day 5, the whole content of container T-201 was pumped into container T-501, then pumped back to container T-201. During pumping, 15 kg of CC8272 demulsifier was added to achieve the desired petrol-biochemical effect. Sampling frequency was decreased to once a day.

On day 15, the heating of middlephase was terminated. It was found, based on the analysis of samples taken on the next day, that the middlephase within the container partially separated into water, crude oil and inorganic solid material. The presence of the deposited inorganic solid material was indicated by the fact that the sample taken through the sampling valve located at 40 cm from the bottom of the container contained grainy material (sand) that have a tendency for sedimentation with a density greater than that of water.

Since no improvement was detected after several days, 36 m³ liquid was pumped from container T-201 into the 60 m³ container T-62. After one day rest, 22 m³ opalescent yellow water was removed from this container. This is 16% of the liquid treated, and it was pumped into water liquidation system.

Next, the middlephase remaining in container T-201 was heated again for better pumping, and then the content was pumped into the 60 m³ containers T-62 and T-65. After a day rest, the water settled into the bottoms of the containers was removed. A further 36 m³ water was pumped into the water liquidation system. In all, 58 m³ water was removed by using the petrol-biochemical method of the invention. This is 42% of the total liquid.

After opening container T-201, the sediment was also removed. The amount of the sediment was 2 m³.

The crude oil floated to the top of the containers, 78 m³ in all, was pumped into container T-1001 for processing.

1. Method for preventing the formation of oil-in-water and/or water-in-oil emulsions and/or for breaking up emulsions already formed, comprising
a) adding tensides, materials for increasing viscosity, industrial surfactants, and microorganisms capable of breaking down crude oil components or derivatives and producing at least one type of tenside, to the emulsion already formed or into the device containing the crude oil in which the formation of the emulsion to be prevented, optionally together with additives required for the reproduction of said microorganisms;
b) providing an appropriate temperature for the microorganisms after the addition of the materials in step a);
c) allowing the microorganisms to reproduce and act for a predetermined period of time;
d) checking the results of the treatment; and
e) optionally repeating steps (a) to (d) at least once more, preferably at least three more times.

2. The method according to claim 1, wherein the said microorganisms and additives are used at the same time, in the form of an aqueous suspension.

3. The method according to claim 1, wherein the suspension of microorganisms contains 10⁶ to 10¹² CFU/liter, preferably 10⁷ to 10¹¹ CFU/liter, more preferably 10⁸ to 10⁹ CFU/liter.

4. The method according to claim 1, wherein the volume of the suspension is 100 to 1000 liter/100 m pipe-length or 50 m³ production, preferably 300 to 800 liter/100 m pipe-length or 50 m³ production, more preferably 500 to 600 liter/100 m pipe-length or 50 m³ production.

5. The method according to claims 1, wherein the volume of the industrial surfactants is 1 to 10 liter/100 m pipe-length or 50 m³ production, preferably 1 to 5 liter/100 m pipe-length or 50 m³ production.

6. The method according to claim 1 for preventing the formation of emulsions, wherein in step d) the results of the treatment are checked by confirming the presence of a film on the surface in contact with the crude oil which provides for the living conditions of the said microorganisms and contains the said microorganisms, and optionally steps a) to d) are repeated by changing the amount of the tenside or material capable increasing viscosity, or by varying the reproduction time of microorganisms.

7. The method according to claim 6, wherein the formation of emulsion is prevented in oil-producing pipes of oil wells.

8. The method according to claim 6, wherein the microorganisms are allowed to reproduce and act for 1 to 15 days, preferably 6 to 8 days, while the pies are kept closed.

9. The method according to claims 6, wherein the results of the treatment are checked by pilot test and/or by confirming the phase separation and/or evaluating the physico-chemical properties, preferably the decrease of viscosity of an oil sample and/or evaluating the drop-size of the asphaltene-paraffin-vax precipitates in an oil-sample by microscopy.

10. The method according to claims 6, wherein the asphaltene-paraffin-vax precipitates are removed from the surface in advance by mechanical means.

11. The method according to claims 1, wherein emulsions already formed in surface producing facilities of oil wells, or highly stable middlephase formed in demulsification facilities of oil producing technologies are broken up.

12. The method according to claim 11, wherein the microorganisms are allowed to reproduce and act for 1 to 15 days, preferably 5 to 8 days, while the devices are kept closed.

13. The method according to claim 11, wherein the temperature is kept between 20 to 60° C., preferably between 40 to 50° C.

14. The method according to claim 11, wherein the results of the treatment are checked by evaluating the physico-chemical properties, preferably the decrease of viscosity of an oil—and/or water-sample, and/or evaluating the drop-size of the asphaltene-paraffin-vax precipitates in an oil-sample by microscopy.

15. The method according to claim 1, wherein the surfactant is selected from the group consisting of polyoxyethylene ethers and esters, and mixtures thereof, preferably Tween 80.

16. The method according to claims 1, wherein the material capable increasing viscosity is xanthan.

17. Use of a microorganism capable of breaking down crude oil components or derivatives and producing at least one type of tenside for preventing the formation of oil-in-water and/or water-in-oil emulsions and/or for breaking up emulsions already formed.

18. The use according to claim 17, wherein prevention of the formation of emulsions is carried out by the formation of bacterium-carrying film on the surfaces in contact with crude oil.

19. The use of claim 17, wherein the microorganism is a strain belonging to the Bacillus subtilis species, the Bacillus cereus species, the Pseudomonas genus or the Xanthomonas genus, and is preferably facultative anaerobic.

20. The use according to claim 17, wherein the microorganism strain is obtainable by the following selection method:
i) applying a film comprising the mineral oil component or derivative to a minimal medium lacking carbon source,
ii) inoculating this medium with a sample comprising a mixture of microorganisms said sample being obtained from an oil pollution, and incubating the medium after inoculation at least till detectable microorganism colonies are formed, if the formation of colonies does not occur within an arbitrarily defined time period step i) and present step ii) are repeated,
iii) decomposing activities of the microorganism from the colonies formed are tested at the surround of the colonies and
iv) tenside producing abilities of the decomposing microorganisms obtained from colonies are checked.

21. The use according to claims 17, wherein the microorganism is selected from the group consisting strains NCAIM (P) B 1304, NCAIM (P) B 1305, NCAIM (P) B 1306, NCAIM (P) B 1307 and NCAIM (P) B 1308 deposited on Apr. 17, 2002 at NCAIM, or any strain derived therefrom, and preferably is a strain that is genetically modified, more preferably modified by the insertion of a DNA fragment with a known sequence as a marker.

22. Kit for preventing the formation of oil-in-water and/or water-in-oil emulsions and/or for breaking up emulsions already formed, comprising a microorganism useful in the method of claim 1, further comprising instructions to carry out the method of claim 1.

23. The kit according to claim 22 comprising one or more microorganisms selected from Bacillus subtilies species, the Bacillus cereus species, the Pseudomonas genus, the Xanthomonas genus, strains NCAIM (P) B 1304. NCAIM (P) B 1305. NCAIM (P) B 1306, NCAIM (P) B 1307 and NCAIM (P) B 1038 deposited on Apr. 17, 2002 at NCAIM, or any strain derived therefrom and additives necessary for the reproduction thereof.

24. The kit according to claim 22 or 23 further comprising a surfactant and/or a material for increasing viscosity.
